(19) United States
(12) Patent Application Publication
(10) Pub. No.: US 2019/0371004 A1
(43) Pub. Date: Dec. 5, 2019

(54) SYSTEM AND METHOD FOR DETERMINING SKIN COLOR, METHOD FOR GENERATING ICC PROFILE, AND IMAGE CAPTURING DEVICE

(71) Applicant: National Applied Research Laboratories, Taipei City (TW)

(72) Inventors: YU-HSUAN LIN, Hsinchu City (TW); ROU-JHEN CHEN, Hsinchu City (TW); CHENG-RU LI, Hsinchu City (TW); KUO-CHENG HUANG, Hsinchu City (TW); MING-YEN LIN, Kaohsiung City (TW); YI-WEN CHIU, Kaohsiung City (TW); SHANG-JYH HWANG, Kaohsiung City (TW); CHIH-YI YANG, Taipei City (TW)

(21) Appl. No.: 16/018,016

(22) Filed: Jun. 25, 2018

(30) Foreign Application Priority Data
Jun. 4, 2018 (TW) 107119202

(51) Int. Cl. G06T 7/90; G06T 1/00; G06T 7/41; G06T 7/80; G03B 17/18

(52) U.S. Cl. CPC G06T 7/90; G06T 1/0007; G03B 17/18; G06T 7/80; G06T 7/41

(57) ABSTRACT

The present invention provides a method and system for determining skin color, method for generating an ICC profile and an image capturing device. The method for determining a skin color includes: providing an image capturing device including a light sensing module and a light distributing module, in which the light distributing module includes a light source and a light isolation tube, the light isolation tube has a first end connected to the light sending module and a second end away from the light source, the light source is disposed on the first end, and the second end has an opening; capturing a first image of an area under test of a human body using the image capturing device, wherein the opening adheres to the area under test such that the image capturing device forms a darkroom environment with respect to the area under test.

### FIELD OF THE INVENTION

The present invention relates to a system and method for determining skin color and an image capturing device, and in particular, to a system and method for determining skin color, a method for generating an ICC (International Color Consortium) profile, and an image capturing device for determining a skin color.

### BACKGROUND

Skin measurement methods in the prior art can be classified into contact measurement and image measurement. The working principle of contact measurement is to obtain a quantitative value related to the physical condition of the skin using a capacitance probe that contacts an area of skin, and then the dielectric constant variation in the measuring material is measure. In image measurement, an image of skin is captured using a camera, in which the image is processed with color analysis method. For example, the image can be divided into sub-areas, and then statistics related to color distribution, color occurrence frequency, and color block variation are collected for specific colors or skin features.

However, the conventional method of contact measurement has a risk of infection, and the conventional skin color analysis uses a relative standard which makes it difficult to apply a standard analysis process to skin colors of all races. In addition, most of the existing skin measurement instruments are configured to detect skin conditions such as water content, oil distribution, or the appearance of the skin such as skin pigmentation, skin textures, and acne scars. Therefore, it is difficult to apply skin measurement instruments in the prior art to measure physiological conditions of a subject.

Although there are some skin measurement instruments on the market that provide physiological information, such as optical reflection-type blood oxygen detection products, these instruments are mostly inconvenient to carry, and for portable ones, the accuracy cannot reach the standard of a medical diagnostic level. In addition, this type of instrument lacks a universal color standard. For example, this type of instrument compares the relative difference between skin colors in different areas in a regionalized skin image to find out the redness or dark spots. However, medical-level skin detection requires a measurement method applicable to subjects of all skin colors. Therefore, there is room for improvement in the field of skin measurement.

### SUMMARY

Based on the above, one of the objectives of the present invention is to provide a system and method for determining a skin color, a method for generating an ICC profile, and an image capturing device for determining a skin color, which provide a portable darkroom environment to achieve environment and light source control, thereby providing accurate skin color measurement.

A technical solution used in an embodiment of the present invention is to provide a method for determining a skin color, including: providing an image capturing device including a light sensing module and a light distributing module, wherein the light distributing module includes a light source and a light isolation tube, the light isolation tube having a first end connected to the light sensing module and a second end away from the light source, the light source being disposed on the first end, and the second end having an opening; capturing a first image of an area under test of a human body using the image capturing device, wherein the opening adheres to the area under test such that the image capturing device forms a darkroom environment with respect to the area under test; performing color calibration on the first image according to an ICC profile using a control unit; and generating a calibrated image using the control unit to determine a skin color of the area under test.

A technical solution used in another embodiment of the present invention is to provide a method for generating an ICC profile, including: providing an image capturing device, including: a light sensing module; and a light distributing module including a light source and a light isolation tube, wherein the light isolation tube has a first end connected to the light sending module and a second end away from the light source, the light source being disposed on the first end, and the second end having an opening; capturing an image of a standard color card using the image capturing device, wherein the standard color card is located on a carrier, the standard color card can pass through the opening with the opening adhering to the carrier such that the image capturing device and the carrier together form a darkroom environment with respect to the standard color card; and generating an ICC profile of the image capturing device according to the standard color card and the image using the control unit.

A technical solution used in another embodiment of the present invention is to provide an image capturing device for determining a skin color, including: a light sensing module; and a light distributing module including a light source and a light isolation tube, wherein the light isolation tube has a first end connected to the light sending module and a second end away from the light source, the light source being disposed on the first end, and the second end having an opening, in which the image capturing device is configured to capture a first image of an area under test of a human body, wherein the opening adheres to the area under test such that the image capturing device forms a darkroom environment with respect to the area under test.

A technical solution used in another embodiment of the present invention is to provide a system for determining a skin color, including: a light sensing module, a control unit, and a light distributing module. The control unit is electrically connected to the image capturing device. The light distributing module includes a light source and a light isolation tube, wherein the light isolation tube has a first end connected to the light sending module and a second end away from the light source. The light source is disposed on the first end, and the second end has an opening. The light distributing module includes a light source and a light isolation tube, wherein the light isolation tube has a first end connected to the light sensing module and a second end away from the light source. The light source is disposed on the first end, and the second end has an opening. The image capturing device is configured to capture a first image of an area under test of a human body, where the opening adheres to the area under test such that the image capturing device forms a darkroom environment with respect to the area under test. The control unit is configured to perform color calibration on the first image according to an ICC profile so as to generate a calibrated image.

To further understand the features and technical solutions of the present invention, please refer to the following detailed descriptions and drawings related to the present invention. However, the appended drawings and descriptions are used only for the purpose of describing the present invention, and are not intended to limit the present invention.

### BRIEF DESCRIPTION OF THE DRAWINGS

FIG. 1 is a functional block diagram of a system for determining skin color according to a first embodiment of the present invention.

FIG. 2 is a three-dimensional schematic diagram of the system for determining skin color performing skin color determination on an area under test according to the first embodiment of the present invention.

FIG. 3 is a three-dimensional schematic diagram of a light distributing module according to the first embodiment of the present invention.

FIG. 4 is a flowchart of a method for determining skin color according to the first embodiment of the present invention.

FIG. 5 is a flowchart of a varied embodiment of the method for determining skin color according to the first embodiment of the present invention.

FIG. 6 is a pixel color statistical chart according to the first embodiment of the present invention.

FIG. 7 is a varied embodiment of the pixel color statistical chart according to the first embodiment of the present invention.

FIG. 8 is a flowchart of another varied embodiment of the method for determining a skin color according to the first embodiment of the present invention.

FIG. 9 is a pixel contribution statistical chart according to the first embodiment of the present invention.

FIG. 10 is a flowchart of a method for generating an ICC profile according to a second embodiment of the present invention.

FIG. 11 is a schematic diagram of the implementation of step S200 in FIG. 10.

### DETAILED DESCRIPTION

A system and method for determining a skin color, a method for generating an ICC profile, and an image capturing device that are disclosed in the present invention are described below with preferred embodiments and appended drawings. A person skilled in the art can learn the advantages and effects of the present invention according to the content disclosed in this specification. However, the content disclosed below is not intended to limit the scope of protection of the present invention. Without departing from the spirit of the idea of the present invention, a person skilled in the art can implement the present invention based on different viewpoints and applications using other embodiments. In addition, it needs to be stated in advance that the accompanying drawings of the present invention are only for illustrative purposes and are not depicted according to actual dimensions. In addition, although various elements in this text may be described using terms such as first, second, and third, these elements should not be limited by these terms. These terms are mainly used for distinguishing between elements.

### First Embodiment

Referring to FIG. 1, FIG. 1 is a functional block diagram of a system Z for determining skin color according to a first embodiment of the present invention. The system Z for determining skin color includes a light sensing module 10 and a light distributing module 20. The light distributing module includes a light source 21 and a light isolation tube 22. The system Z for determining skin color further includes a control unit 2 and an output unit 3. The control unit 2 is electrically connected to an image capturing device 1, and the output unit 3 is connected to the control unit.

The manner of connection between the image capturing device 1 and the control unit 2 is not limited in the present invention. In addition, in this embodiment, the control unit 2 is connected to the light source 21 through a control circuit so as to control the light source 21. However, the present invention is not limited thereto.

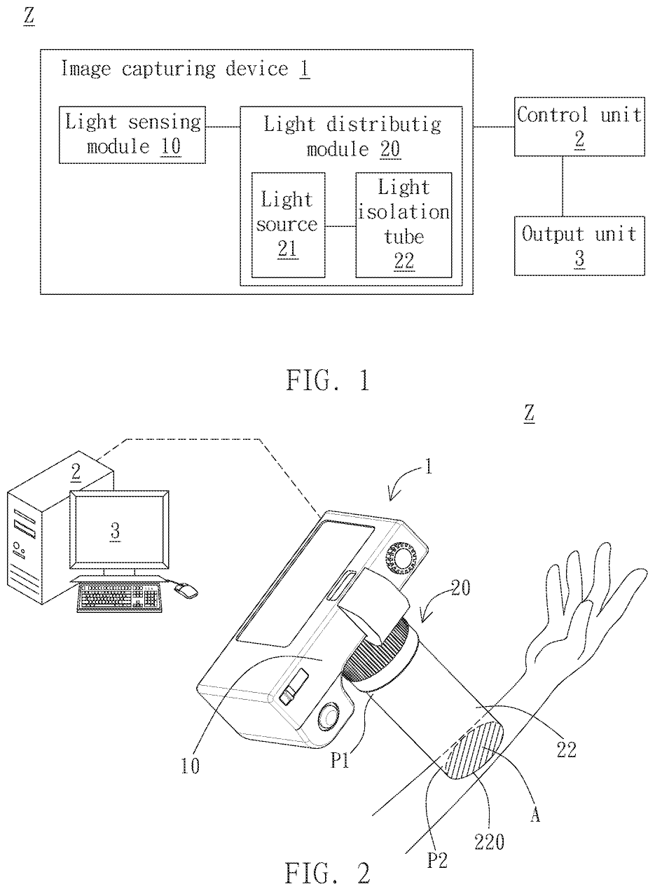

Further referring to FIG. 2, specifically, in this embodiment, the light sensing module 10 is a CCD camera, the control unit 2 is a desktop computer, and the output unit is a computer screen. However, the present invention is not limited thereto. For example, in other embodiments, the light sensing module 10 may be a CMOS camera, and the control unit 2 and the output unit 3 may be respectively a central controller and a screen of a palmtop processor.

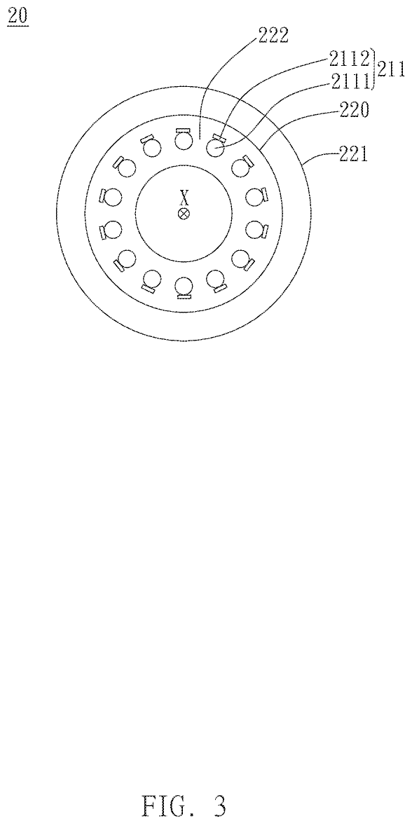

As shown in FIG. 2, the light isolation tube 22 of the light distributing module 20 has a first end P1 connected to the light sensing module 10 and a second end P2 away from the first end P1, and the second end P2 has an opening 220. Further referring to FIG. 3, FIG. 3 is a front view of the second end P2 of the light distributing module 20. As shown in FIG. 3, the light isolation tube 22 includes a tube body 221 and a light source setting portion 222. The light source setting portion 222 is formed by extending the first end P1 towards a central axis X of the tube body 221, and the light source 21 is disposed on the light source setting portion 222.

Furthermore, the light source 21 is a plurality of light emitting units 211 arranged in an annular shape. Each light emitting unit 211 has a light emitting element 2111 and an angle adjustment element 2112. The angle adjustment element 2112 can be configured to adjust a light emitting angle of the light emitting element 2111. For example, when the brightness of a part of an area under test A needs to be highlighted, or light amount of light rays in certain incident angles needs to be increased, adjustment can be performed using the angle adjustment element 2112. However, the present invention is not limited thereto. In other embodiments, the light emitting unit 211 may also include only the light emitting element 2111.

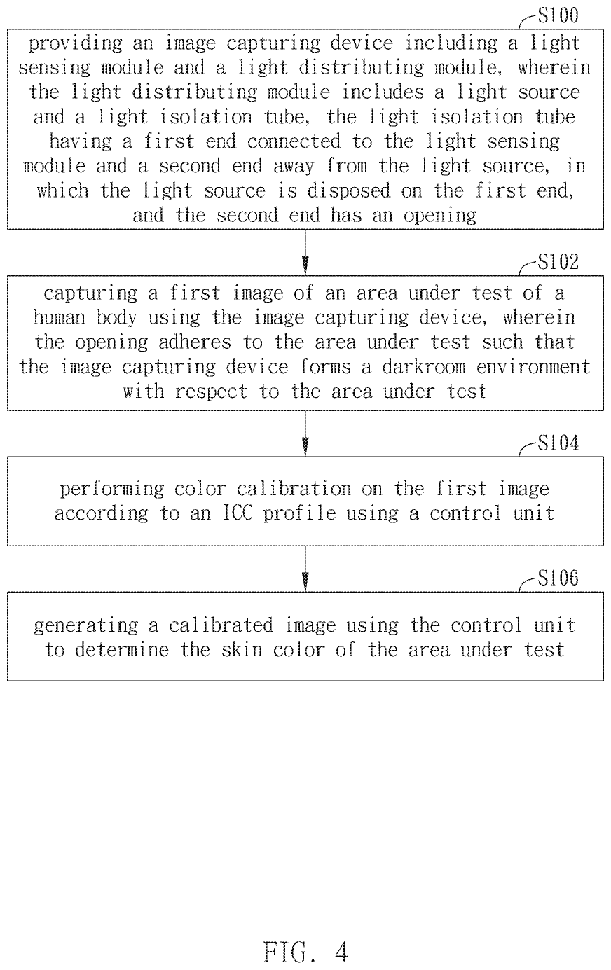

Referring to FIG. 2 and FIG. 4, the first embodiment of the present invention provides a method for determining skin color using the system Z for determining a skin color, the method including the following steps: Step S100: Providing an image capturing device 1 including a light sensing module 10 and a light distributing module 20, in which the light distributing module 20 includes a light source 21 and a light isolation tube 22, the light isolation tube 22 has a first end P1 connected to the light sending module 10 and a second end P2 away from the light source 21, the light source 21 is disposed on the first end P1, and the second end P2 has an opening 220. Step S102: Capturing a first image of an area under test A of a human body using the image capturing device 1, in which the opening 220 of the light isolation tube 22 adheres to the area under test A such that the image capturing device 1 forms a darkroom environment with respect to the area under test A. Step S104: Performing color calibration on the first image according to an ICC profile using a control unit 2. Step S106: Generating a calibrated image using the control unit 2 so as to determine a skin color of the area under test A.

As shown in FIG. 2, according to the method for determining skin color of this embodiment, the opening 220 of the light isolation tube 22 adheres to the area under test A when the image of the area under test A is captured, thereby forming a darkroom structure with respect to the area under test A. In this way, negative environmental effects on the first image such as noise and color differences due to external ambient light can be prevented.

In addition to control over ambient light, control over a light source is also an important factor in the improvement of the image definition and color rendition. In detail, an inner wall surface of the light isolation tube 22 of this embodiment is formed of a light-absorbing material, and the light source 21 has a high color rendering index and is arranged in an annular shape. For instance, the color rendering index (CRI) of the light source 21 in this embodiment is 90 or greater than 90. However, the present invention is not limited thereto. Furthermore, a distance from the first end P1 to the second end P2 of the light isolation tube 22 of this embodiment is obtained through optimization calculation. The distance enables the light source 21 to exhibit high uniformity when the light is transmitted from the first end to the second end. Preferably, the distance helps achieve light uniformity of greater than 95%.

Through the aforementioned technical solution, when capturing the image in the area under test A, the image capturing device 1 can block ambient light with the light isolation tube 22 of the light distributing module 20, and obtain the image of the area under test A of low color difference and low noise with the light source 21 having a high color rendering index and high uniformity.

In this embodiment, color calibration in step S104 is performed on the first image using the ICC profile pre-stored in the control unit 2. The manner of generating the ICC profile is not limited in this embodiment. For example, the ICC profile may be generated using the method for generating an ICC profile provided in a second embodiment, or may be provided by a manufacturer of the image capturing device 1. The method for generating an ICC profile provided in the present invention will be described in detail in the second embodiment.

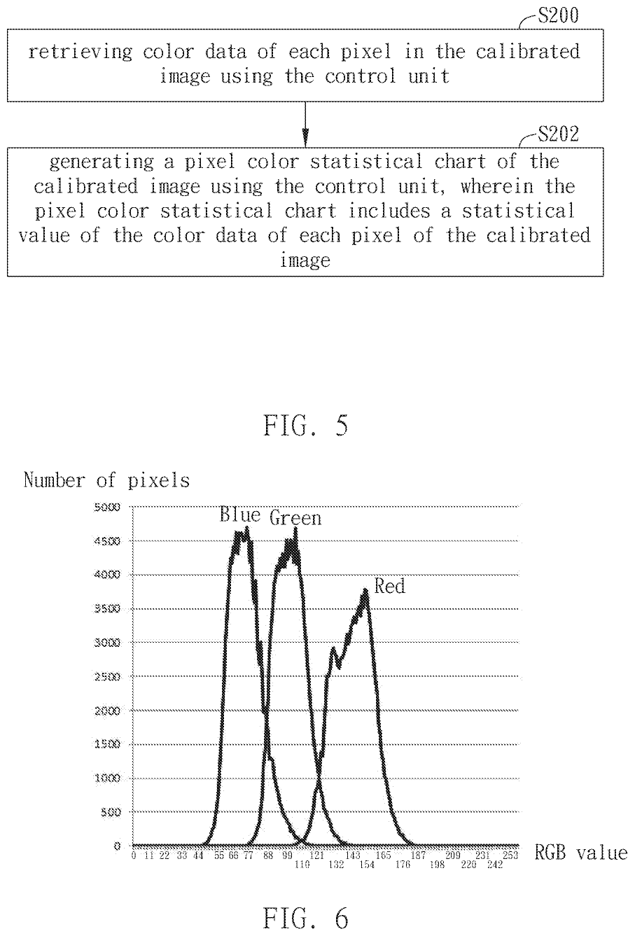

In this embodiment, after performing step S106, the control unit 2 may display the calibrated image using the output unit 3 for a user to determine the skin color of the area under test A. Furthermore, referring to FIG. 5, in a varied embodiment, the method for determining skin color of the present invention may further include step S200: retrieving the color data of each pixel in the calibrated image using the control unit 2, and step S202: generating a pixel color statistical chart of the calibrated image using the control unit 2.

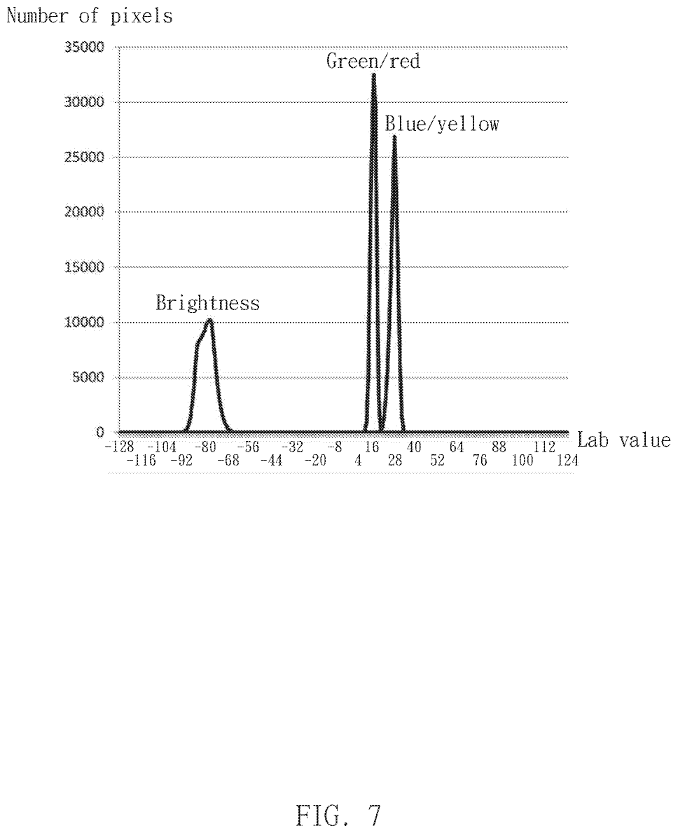

Specifically, the color data can be an RGB value, or other color description data according to another color representation system, and is not limited in the present invention. Referring to FIG. 6, in step S202, the control unit 2 generates an RGB diagram, wherein the longitudinal axis represents the number of pixels corresponding to the RGB value of each color in the calibrated image. The form of the pixel color statistical chart is not limited in the present invention. In other varied embodiments, the control unit 2, for example, can also generate a table, and the pixel contribution number corresponding to each RGB value is represented in a numeric manner. Alternatively, in another varied embodiment, a Lab color spatial distribution diagram of the calibrated image can be generated, as shown in FIG. 7. In this varied embodiment, RGB values are first converted using, for example, the control unit 2.

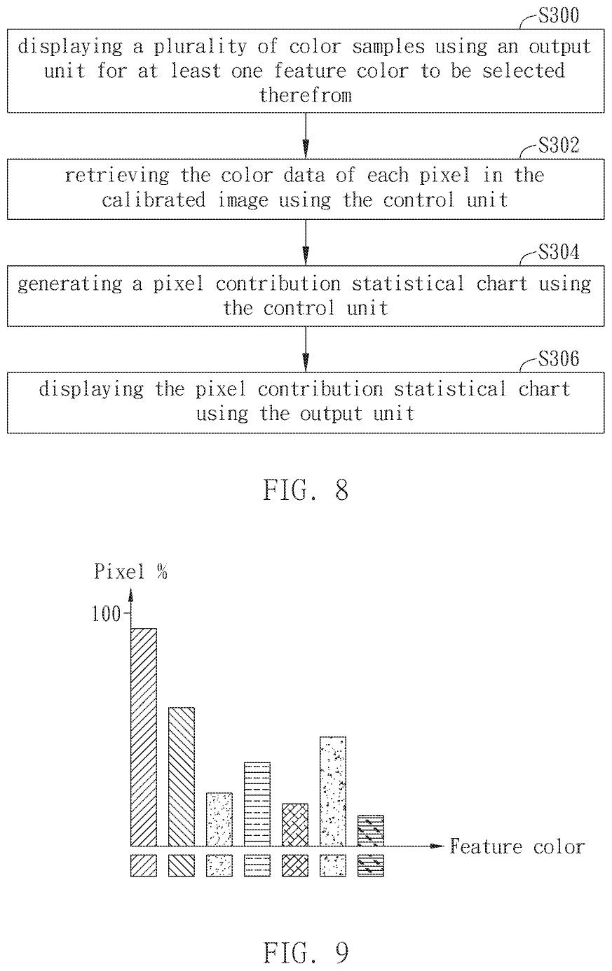

Furthermore, referring to FIG. 8, in another varied embodiment, the method for determining skin color of the present invention may further include step S300: displaying a plurality of color samples using the output unit 3 for at least one feature color to be selected therefrom; step S302: retrieving the color data of each pixel in the calibrated image using the control unit 2; step S304: generating a pixel contribution statistical chart using the control unit 2; and step S306: displaying the pixel contribution statistical chart using the output unit 3.

For example, referring to FIG. 9, in a medical case, a medical staff needs to determine a distribution proportion of seven specific colors in an area under test of a patient so as to make a diagnosis. Then the output unit 3 can display a color sample library for the medical staff to select. After the medical staff selects the seven color samples indicated by the horizontal axis shown in FIG. 9 as feature colors, the control unit 2 retrieves color data of each pixel in the calibrated image, and subsequently generates a pixel contribution statistical chart of the calibrated image shown in FIG. 9. The longitudinal axis displays a proportion of pixels contributing to each feature color in the calibrated image. Similarly, the manner of presenting the pixel contribution statistical chart is not limited in the present invention. For example, in other embodiments, the longitudinal axis in FIG. 9 may also represent a total number of pixels contributing to each feature color. Alternatively, in other embodiments, the pixel contribution statistical chart may also be represented by a table or a fan diagram.

Through the aforementioned technical solution, with the light distributing module 20, the system for determining skin color of this embodiment of the present invention can form a darkroom environment through adhesion to the area under test when the area under test A of the body of the subject is photographed. In addition, the length of the light isolation tube 22 of the light distributing module 20 is optimized, and an inner wall thereof is a light-absorbing material. Moreover, in cooperation with a light source having a high color rendering index, a light source of high uniformity can be provided to photograph the area under test A. Furthermore, the light sensing module 10 is portable, and can improve the motility of implementation of medical skin measurement. Based on the above, the system for determining skin color of this embodiment of the present invention and the method using the same can achieve a portable darkroom environment so as to improve the image quality and color rendition when performing skin measurement.

### Second Embodiment

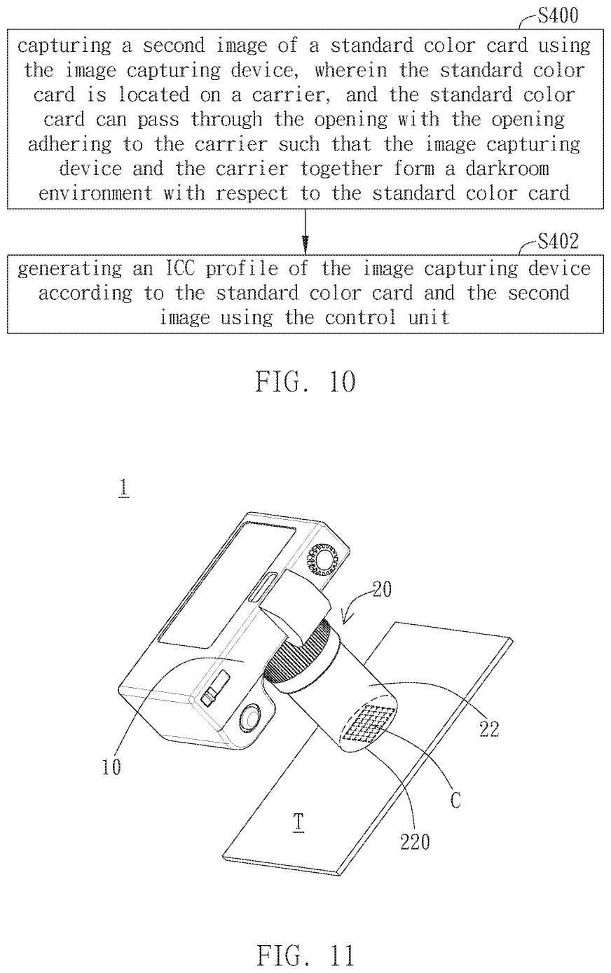

Referring to FIG. 10, a second embodiment of the present invention provides a method for generating an ICC profile, including step S400: capturing a second image of a standard color card C using an image capturing device 1, wherein the standard color card C is located on a carrier T, the standard color card can pass through an opening 220 of a light isolation tube 22 with the opening 220 adhering to the carrier T such that the image capturing device 1 and the carrier T together form a darkroom environment with respect to the standard color card C; and step S402: generating an ICC profile of the image capturing device 1 according to the standard color card C and the second image using a control unit 2.

Referring to FIG. 11, in step S400, the opening 220 adheres to the carrier T so as to form a darkroom environment with respect to the standard color card C. Therefore, the color difference and environmental noise in the second image of the standard color card C can be reduced. In step S402, the control unit 2 generates an ICC profile by comparing the color data of the standard color card with the color data of the second image for color calibration of the image later generated by the image capturing device 1.

Through the aforementioned solution, the second embodiment of the present invention provides an ICC profile for accurate color calibration by light and environmental control in the process of photographing a standard color card. It is worth mentioning that step S402 may further include a step of performing a mapping regression algorithm to further correct the ICC profile through a polynomial regression analysis method. In this way, the color realness of the calibrated image on which color calibration is performed using the ICC profile can be further improved.

Based on the above, through the technical solutions of “the light isolation tube has a first end connected to the light sending module and a second end away from the light source, the light source being disposed on the first end, and the second end having an opening” and “the opening adheres to the area under test” provided in the embodiments of the present invention, the image capturing device can form a darkroom environment with respect to an area under test. In this way, a portable darkroom environment can be achieved when performing skin measurement, thereby providing accurate skin color detection and skin color image calibration.

The content disclosed above is only preferred embodiments of the present invention, and is not intended to limit the scope of the present invention. Therefore, any equivalent technical variation made based on the specification and the drawings of the present invention falls into the scope of the present invention.

What is claimed is:

1. A method for determining a skin color, comprising:
providing an image capturing device including a light sensing module and a light distributing module, wherein the light distributing module comprises a light source and a light isolation tube, the light isolation tube having a first end connected to the light sensing module and a second end away from the light source, in which the light source is disposed on the first end, and the second end has an opening;
capturing a first image of an area under test under test of a human body using the image capturing device, wherein the opening adheres to the area under test such that the image capturing device forms a darkroom environment with respect to the area under test;
performing color calibration on the first image according to an ICC profile using a control unit; and
generating a calibrated image using the control unit to determine the skin color of the area under test.

2. The method for determining a skin color according to claim 1, wherein the step of performing color calibration on the first image according to an ICC profile using a control unit further comprises:
capturing a second image of a standard color card using the image capturing device, wherein the standard color card is located on a carrier, the standard color card can pass through the opening, and the opening adheres to the carrier such that the image capturing device and the carrier together form a darkroom environment with respect to the standard color card; and
generating the ICC profile of the image capturing device according to the standard color card and the second image using the control unit.

3. The method for determining a skin color according to claim 1, wherein after the step of generating a calibrated image using the control unit to determine a skin color of the area under test, the method further comprises:
retrieving color data of each pixel in the calibrated image using the control unit; and
generating a pixel color statistical chart of the calibrated image using the control unit, wherein the pixel color statistical chart comprises a statistical value of the color data of each pixel of the calibrated image.

4. The method for determining a skin color according to claim 1, wherein after the step of generating a calibrated image using the control unit, to determine a skin color of the area under test, the method further comprises:
displaying a plurality of color samples using an output unit for at least one feature color to be selected therefrom;
retrieving the color data of each pixel in the calibrated image using the control unit;
generating a pixel contribution statistical chart using the control unit, wherein the pixel contribution statistical chart comprises a number of pixels having color data the same as that of each feature color in the calibrated image; and
displaying, the pixel contribution statistical chart using the output unit.

5. A method for generating an ICC profile, comprising:
providing an image capturing device, the device comprising:
a light sensing module; and
a light distributing module comprising a light source and a light isolation tube, wherein the light isolation tube has a first end connected to the light sending module and a second end away from the light source, in which the light source is disposed on the first end, and the second end has an opening;
capturing an image of a standard color card using the image capturing device, wherein the standard color card is located on a carrier, the standard color card can pass through the opening with the opening adhering to the carrier such that the image capturing device and the carrier together form a darkroom environment with respect to the standard color card; and
generating an ICC profile of the image capturing device according to the standard color card and the image using the control unit.

6. An image capturing device for determining a skin color, comprising:
a light sensing module; and
a light distributing module comprising a light source and a light isolation tube, wherein the light isolation tube has a first end connected to the light sending module and a second end away from the light source, the light source is disposed on the first end, and the second end has an opening; and wherein
the image capturing device is configured to capture a first image of an area under test of a human body, wherein the opening adheres to the area under test such that the image capturing device forms a darkroom environment with respect to the area under test.

7. The image capturing device according to claim 6, wherein a color rendering index (CRI) of the light source is greater than or equal to 90.

8. The image capturing device according to claim 6, wherein an inner wall surface of the light isolation tube is formed of a light-absorbing material.

9. The image capturing device according to claim 6, wherein the light isolation tube has a tube body and a light source setting portion, the light source setting portion being formed by extending the first end towards a central axis of the tube body, and the light source is disposed on the light source setting portion.

10. The image capturing device according to claim 6, wherein the light source includes a plurality of light emitting units, each light emitting unit having a light emitting element and an angle adjustment element, and the angle adjustment element is configured to adjust a light emitting angle of the light emitting element.

11. A system for determining a skin color, comprising:
the image capturing device according to claim 6; and
a control unit, electrically connected to the image capturing device, wherein the control unit is configured to perform color calibration on the first image according to an ICC profile, to generate a calibrated image.

12. The system for determining a skin color according to claim 11, wherein the image capturing device is configured to capture a second image of a standard color card, the standard color card being disposed on a carrier, in which the standard color card can pass through the opening with the opening adhering to the carrier such that the image capturing device and the carrier together form a darkroom environment with respect to the standard color card; and the control module is configured to generate the ICC profile according to the second image and the standard color card.

13. The system for determining a skin color according to claim 11, wherein the control unit is configured to retrieve the color data of each pixel in the calibrated image so as to generate a pixel color statistical chart of the calibrated image, in which the pixel color statistical chart includes a statistical value of the color data of each pixel in the calibrated image.

14. The system for determining a skin color according to claim 11, wherein the control unit is configured to retrieve the color data of each pixel in the calibrated image, and generate a pixel contribution statistical chart according to at least one feature color, the pixel contribution statistical chart including a number of pixels in the calibrated image having color data the same as that of each feature color.

15. The system for determining a skin color according to claim 14, further comprising: an output unit connected to the control unit, wherein the output unit is configured to display a plurality of color samples for at least one feature color to be selected therefrom, and display the pixel contribution statistical chart.
